(19) United States
(12) Patent Application Publication
(10) Pub. No.: US 2021/0002952 A1
(43) Pub. Date: Jan. 7, 2021

(54) VERTICAL RETRACTABLE COVERING FOR STRUCTURAL OPENINGS

(71) Applicant: Edwin Torres, Cape Coral, FL (US)

(72) Inventor: Edwin Torres, Cape Coral, FL (US)

(21) Appl. No.: 16/854,958

(22) Filed: Apr. 22, 2020

Related U.S. Application Data
(60) Provisional application No. 62/921,657, filed on Jul. 1, 2019.

(51) Int. Cl. E06B 9/262; E06B 9/58

(52) U.S. Cl. CPC E06B 9/262; E06B 2009/583; E06B 2009/2625; E06B 9/58

(57) ABSTRACT

The invention relates to a retractable coverings for architectural openings that can accommodate different pleated fabric covering sizes without requiring the use of different side rail frame components and is capable of opening either from left to right, right to left or a two-piece construction allowing for the left side to open left and right side to open left.

### CROSS-REFERENCE TO RELATED APPLICATION

This application claims priority from U.S. Provisional Patent Application No. 62/921,657, filed Jul. 1, 2019, titled Vertical Retractable Covering for Structural Openings which is hereby incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention and the applicants make no claim to any trademarks referenced.

### BACKGROUND OF THE INVENTION

### 1) Field of the Invention

The invention relates to covering structural openings, and, more particularly to covering structural openings such as doorways, windows, archways, or the like.

### 2) Description of Related Art

Retractable pleated fabric covering coverings for architectural openings, such as windows, doorways, archways, and the like, have taken numerous forms for many years. Some such coverings are in the form of horizontally collapsible panels suspended from a headrail and having one edge connected to a fixed vertical rail and the opposite edge to a movable vertical rail. A trolley is secured to the top of the movable vertical rail and has a horizontal arm supported by and movable along the length of the headrail. The horizontal arm is typically six or so inches in length and includes two pair of horizontally disposed rollers which are disposed at opposite ends of the horizontal arm for rolling movement along the headrail. A problem with prior art retractable pleated fabric covering panels resides in the fact that the panel itself is suspended from the headrail by a plurality of carriers which are also movable along the length of the headrail and supported on a common track with the trolley. Accordingly, the carriers interfere with the trolley at the connection of the retractable panel to the trolley, and as a result, an aesthetic interruption in the panel occurs.

A significant problem with the prior art is the number of different parts required to assemble a retractable covering for architectural openings and the need to have different size side rail frame materials to accommodate the various sizes of fabric used to form the retractable coverings for architectural openings.

Therefore, what is needed in the art is a new and improved system for connecting a retractable vertical panel to a trolley and a headrail along which the trolley can translate without detracting from the aesthetics of the panel and a frame system which can accommodate different fabric sizes.

### BRIEF SUMMARY OF THE INVENTION

The invention in one form is directed to a retractable coverings for architectural openings that can accommodate different pleated fabric covering sizes without requiring the use of different side rail frame components and is capable of opening either from left to right, right to left or a two piece construction allowing for the left side to open left and right side to open right.

The invention in another form provides for a reversable trolley that is capable of supporting the moveable vertical rail and the fix vertical rail and an integral hinge which allows it to swivel.

In yet another form, the invention the instant invention provides for a reinforcing system that attaches the fabric panel to the carriers that travel on a track of the headrail.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an isometric of a side-draw embodiment of the instant invention with the pleated fabric covering in a fully extended position.

FIG. 2 is an isometric showing the covering of FIG. 1 in a partially retracted position.

FIG. 3 is an isometric of a center-draw system in accordance with the instant invention where two separate panels are anchored along their outer side edges to the vertical sides of the architectural opening and have a movable edge fully extended so as to confront the movable edge of the opposite panel at the longitudinal center of the headrail.

FIG. 4 is an isometric similar to FIG. 3 showing both panels partially retracted.

FIG. 5 is a front diagrammatic elevation of a side-draw system of the type shown in FIGS. 1 and 2 with the panel partially retracted and the fixed edge of the panel being along the left side of the covering.

FIG. 6 is the union of the headrail of the instant invention.

FIG. 7 is an enlarged view of the center-drawn system with partially extended coverings on both sides of the structural opening as depicted in FIG. 3 and FIG. 4.

FIG. 8-A is an enlarged section plan view taken with respect to the ¾ inch covering and both vertical rails.

FIG. 8-B is an enlarged section plan view taken with respect to the 9/16 inch covering and both vertical rails.

FIG. 9 is an enlarged section through the headrail, vertical rail, valence, and the basic components.

FIG. 10 is an enlarged section through the headrail and vertical rail showing adhesive fabric reinforcement.

FIG. 11 is a see-through x-ray fragmentary isometric view of the trolley with corresponding assembly components.

FIG. 12 is a section taken through the trolley and illustrates the engagement of the swiveling plate.

FIG. 13 is a view of the trolley, with the swiveling plate, and vertical rail.

FIG. 14 is an oppositional view of the trolley, the swiveling plate, and vertical rail.

FIG. 15 is an enlarged isometric view of the trolley, pivoting base, and the swiveling plate.

FIG. 16 is an enlarged exploded solid surface isometric view of the trolley, pivoting base, and the swiveling plate.

FIG. 17 is a section with diagrammatic view of the trolley and headrail components.

FIG. 18 is a view of the of the movable rail pivoting towards the structural opening.

FIG. 19 is a view of the of the movable rail pivoting away from the structural opening.

FIG. 20 is an isometric view of the cord guide end cap and the movable rail.

FIG. 21 is a cross section of the headrail

FIG. 22 is an exploded isometric view showing the cord cap.

FIG. 23 is a diagrammatic view of the headrail.

FIG. 24 is a diagrammatic isometric view similar to FIG. 1 showing the instant invention with the shade covering having been removed while illustrating the cord system for maintaining a parallel relationship between the fixed and movable vertical rails of the covering.

FIG. 25 is a diagrammatic isometric view similar to FIG. 24 but instead showing a center-drawn cord system with (2) two movable rails and (2) two fixed vertical rails.

FIG. 26 is an isometric view similar FIG. 2 with the shade covering removed to further illustrate the cord system.

FIG. 27 is a diagrammatic isometric view similar to FIG. 25 but instead showing a center-drawn cord system with the shade covering having been removed while illustrating the cord system for maintaining a parallel relationship between the fixed and movable vertical rails of the covering.

FIG. 28 is an enlarged exploded view of the instant invention illustrating the relationship of the headrail, trolley, vertical rail, the covering, the cord system, and the end plate with the pleated fabric covering being partially excluded so as to view the method for maintaining a parallel relationship of the vertical rails and covering material.

FIG. 29 is a front section illustrating the headrail and covering material

FIG. 30 is a rear through section illustrating the rear of the valence, headrail, and covering material. Also shown, is the method of gathering the covering with the use of roller bearings, rail carriers, and fabric carriers.

FIG. 31 is a see-through x-ray isometric view of the bottom end cap for the vertical rail and the J-hook being nested within aforementioned bottom end cap.

FIG. 32 is an exploded isometric further illustrating the relationship of the bottom end cap and J-hook assemblies.

FIG. 33 is a detail view of Swiveling plate.

FIG. 34 is a detail view of Pivoting base.

FIG. 35 shows the fabric tape reinforcement.

FIG. 36 shows the fabric reinforcement.

FIG. 37 shows a cross sectional assembly through the hole in the pleated fabric covering of pleated fabric covering, fabric tape reinforcement and fabric carriers.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

As used in the specification the terms trolley and trolley are used interchangeably and are meant to refer to a carrier of supporting a moveable side rail from the headrail.

As used in the specification the term covering, panel, pleated fabric covering are used interchangeably to mean the fabric panel used to cover the structural opening.

The prior art does not provide for a system that provides a system that allows multiple size fabrics to be used with a single vertical rail or a reversable trolly these include U.S. Pat. No. 4,915,153 issued on Apr. 10, 1990, U.S. Pat. No. 6,601,637 issued on Aug. 5, 2003, U.S. Pat. No. 8,469,078 issued on Jun. 25, 2013 the contents of which are incorporated by reference in their entirety.

The invention is an improved expandable and collapsible covering system for selectively covering structural openings such as doorways, windows, archways, or the like, where the covering includes a headrail and a vertically extending, collapsible panel suspended from the headrail having moveable vertical rails which can be locked in a fixed position so neither vertical rail is movable, so both rails are moveable, and so that one rail is fixed or the other is locked.

The instant invention utilizes a four-wheel trolley which rides in a first track and that secures to the upper end moveable rail and a fifth wheel that secures to the forward edge of the moveable rail and rides in a third track. This ensures that the moveable rail hangs straight and does not twist. The four-wheel trolley that secures to the upper end of the movable rail with has a vertical pivoting cylindrical base and swiveling base plate, and the trolley, along with the vertical pivoting cylindrical base, swiveling base plate, and moveable vertical rail facilitate the means by which the covering is expanded or collapsed along the axis of the headrail. The fifth wheel that secures to the forward edge of the moveable rail runs in the second track and eliminates the tendency for the four-wheel trolley to lift up and allows the instant invention to use a smaller trolley which reduces the stack height of the covering when it is collapsed along the axis of the headrail. A clearly defined headrail has two channels, one in which the trolley is moveable along the length of the headrail, and the other in which the covering and roller that supports the forward edge of the moveable rail. The fabric is suspended from independently running rollers which are attached to the fabric such that the support the fabric as the moveable side rail is translated along the axis of the head rail in the first headrail track causing the pleats in the fabric panel to expanded or contract, along the axis of the headrail which supports the pleated fabric covering using carriers which moveable travel in a second track in the headrail. The position of the trolley and covering is maintained and defined by the headrail.

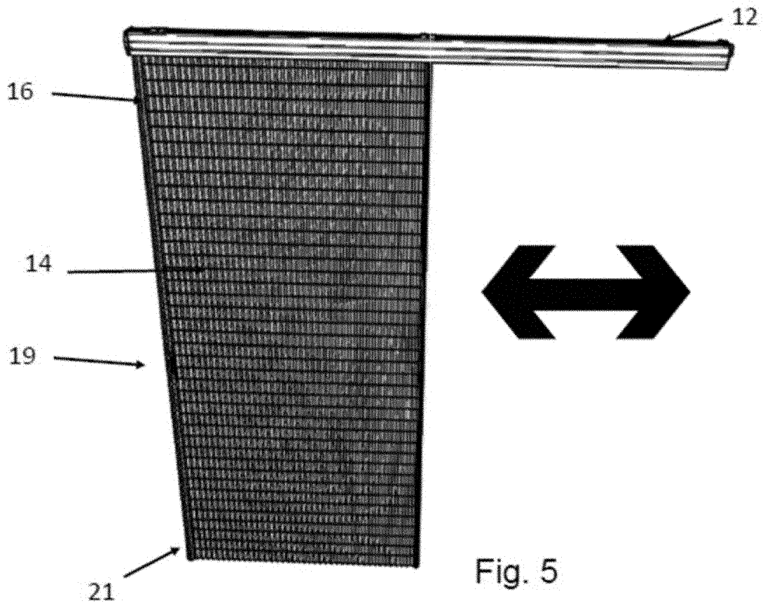

The entirety of the covering is stabilized by two parallel cords that run through the pleated fabric covering allowing the smooth, uniform, and desired appearance of the covering and its operation. Each cord allows travel through the movable rail and is attached at either end of the headrail, tension on the cord is maintained by a spring and an adjustable, lockable cord tensioner. The pleated fabric covering traverses the tension able cord by sliding along its fixed plane via the movable rail, along the length of the headrail. The movable rail has two cord guides 69 shown in FIG. 5D that provide a smooth, uninterrupted passage through the interior of the rail and its axis. This stabilizing cord system exits through the top portion of the movable rail through the cord guide end cap, attached at both ends of the headrail, and any friction or binding is thus reduced, again, allowing for the smooth expansion and contraction of the pleated fabric covering.

The movable rail is supported by a trolley which allows for uninterrupted motion along the headrail axis. As the moveable rail supported by the trolley is rolled along the length of the headrail and each stabilizing cord maintains a fixed spacing of the movable rail(s) and the pleated fabric covering in both the fully expanded and collapsed positions. The stabilizing cord prevents bunching and non-uniform gathering of the covering materials while providing the desired movement and appearance.

The trolley wheels nest inside the track and the top portion of the trolley has a protruding key that ensures that it is always maintained within the headrail horizontally, while the pivoting base prevents the wheels from jumping out of the headrail first track. The trolley wheels can engage both the upper and lower portions of the headrail interior also defining a clear, unrestricted transit for the trolley and attached movable rail.

The expandable and collapsible pleated fabric covering is suspended along the length of the headrail and is movable by means of a plurality of carriers with attached roller bearings that ride in a second track within the headrail assembly that make the assembly slidable within the headrail. The roller bearings travel within a second track within the headrail with a rounded center to minimize friction and noise generated by the rollers during the manipulation of the movable rail. As the pleated fabric pleated fabric covering is retracted, the carriers travel along a common track with no encumbrances, subsequently the trolley travels along its exclusive first track and both the covering, trolley, and moveable rail travel the headrail in unison along the same axis. Because the trolley and the pleated fabric covering transit the headrail independently but in unison, this allows the aesthetically desired operation of the vertical retractable covering for structural openings.

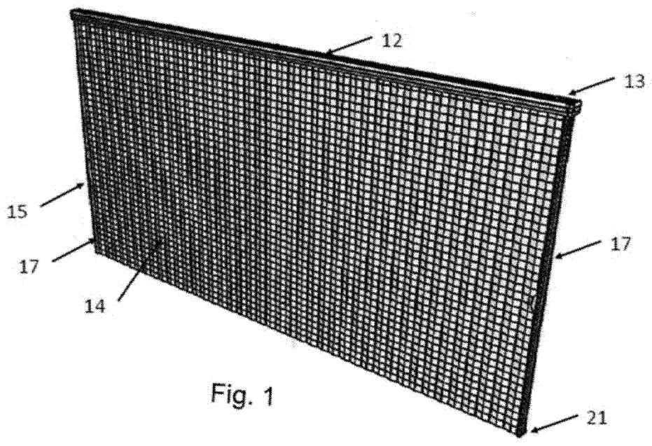

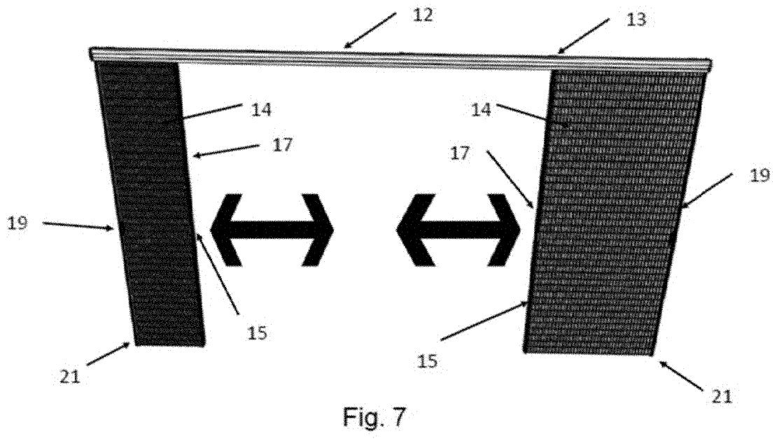

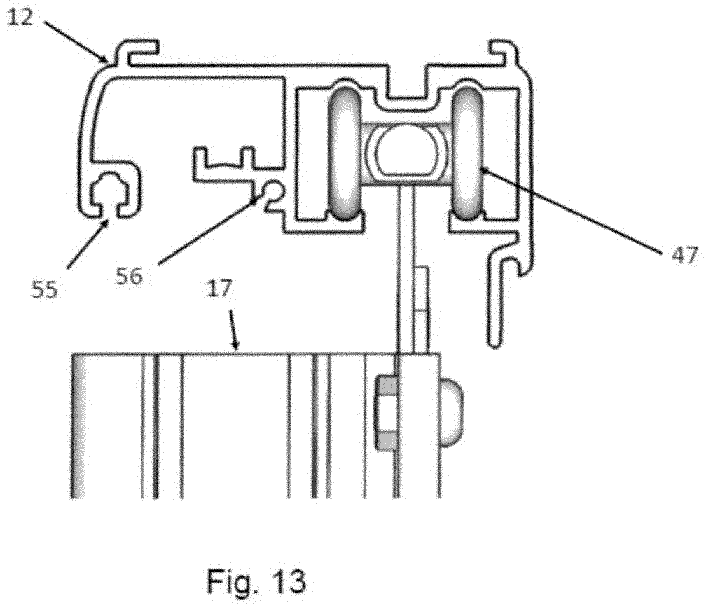

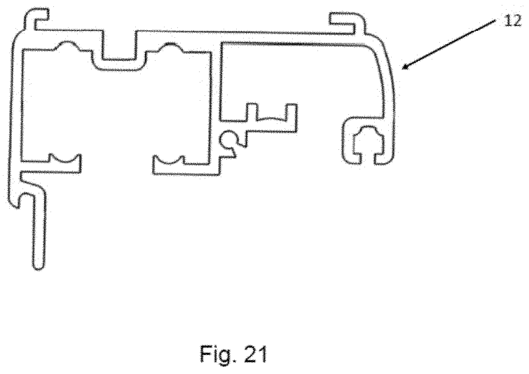

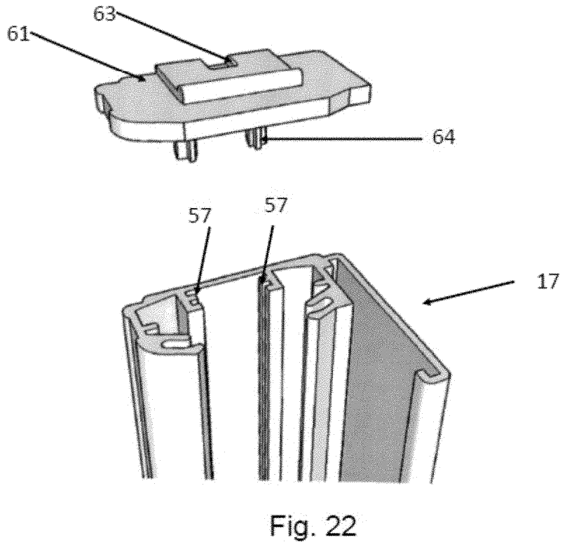

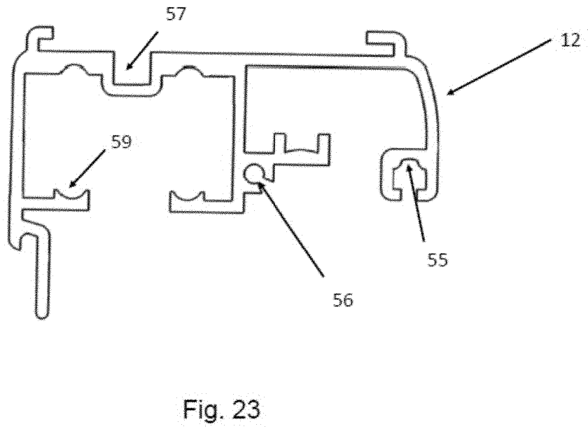

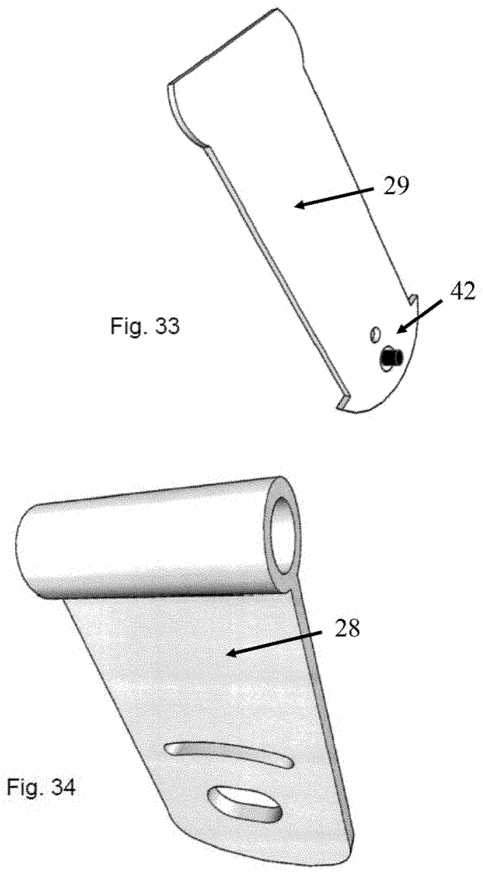

Referring now to the drawings, and more particularly to FIG. 1-34, there is shown vertical retractable covering for structural openings 11 not shown as it applies to this invention, is used primarily for covering structural openings such as doorways, windows, archways, or the like. The movable pleated fabric covering is expandable and collapsible between various positions and includes a headrail 12 attached to a structural member of the wall system (not shown) with an installation bracket 13, which in turn supports a vertically-extending, horizontally expandable and collapsible pleated fabric covering 14 having a vertical edge 15 which is horizontally movable, independently movable from each other, and/or locked at one or both ends depending on the opening configuration selected. Headrail 12. Installation bracket 13, vertical rail 17 are constructed of either steel, aluminum or plastic material.

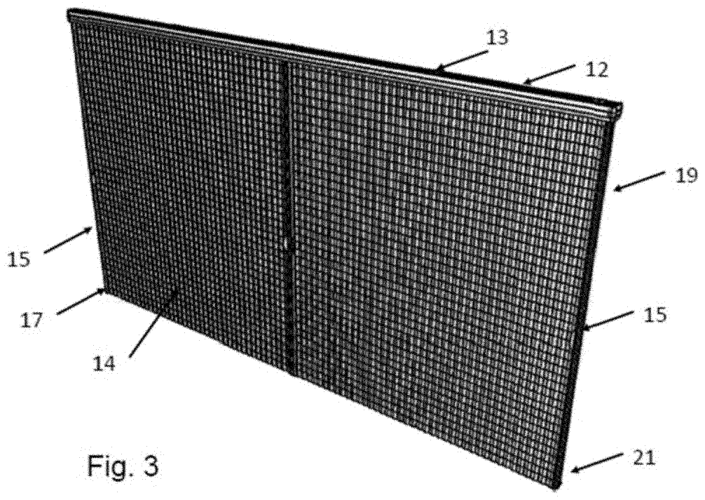

The pleated fabric covering 14 is typically used as a side-draw covering for structural openings, whereas the vertical rail 17 can be configured to be either moveable or fixed. When vertical rail 17 is configured as a moveable rail it can move the entire length of the headrail from one side, side to side because it is suspended from trolley 27. The trolley 27 are constructed of either steel, aluminum or plastic material. Alternatively, it can be positioned in a fixed position and attached to either side with J-hooks 21. This provides significant flexibility for the installer requiring them to only stock one vertical rail 17. In addition, trolley 27 is also reversable and that provides the installer the same flexibility. A center draw covering system FIG. 3 is possible to achieve with the vertical retractable covering for structural openings, as opposing edges can be locked, allowing the installation to have two movable rails formed from vertical rails 17 and two fixed vertical rails 17 as the edge rails. to be expanded to the center of the structural opening and again collapsed to either end of the opening.

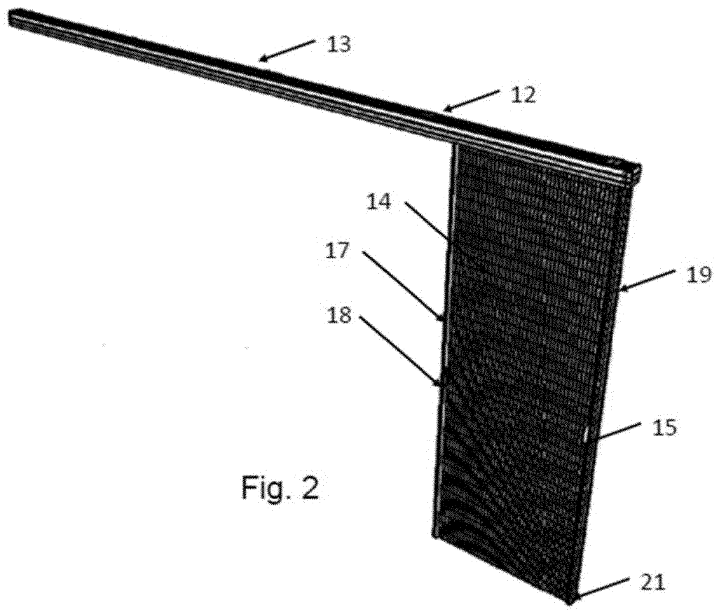

Referring specifically to FIG. 1 which is an isometric drawing of the vertical retractable covering for structural openings 11 not shown with the pleated fabric covering 14 in a closed position, whereas FIG. 2 illustrates the pleated fabric covering 14 in an open position. FIG. 3 illustrates the center draw option as noted above, with appropriate views of the pleated fabric covering 14.

It is possible for the pleated fabric covering 14 to assume and maintain many different drawn or open positions. However, for the purpose of this disclosure, the pleated fabric covering 14 is illustrated in the closed, open, and center drawn positions as depicted in FIGS. 1, 2, and 3.

The pleated fabric covering 14 could by itself assume numerous forms. FIGS. 1-4 illustrate examples of the vertically suspended pleated fabric covering 14. There are an infinite number of pleated fabric covering 14 positions associated with the instant invention. The incorporation of the two-cord stabilizing system ensures the uniform gathering of the covering materials 14 in any position while maintaining a desired parallel alignment of both the movable rail and the fixed rail formed from vertical rail 17 or any combination therein. The instant invention provides the installer additional flexibility as the vertical rail 17 that forms the non-moveable ends also hangs from the trolley 17 reducing the total number of unique parts need to assemble the vertical retractable covering for structural openings 11 not shown.

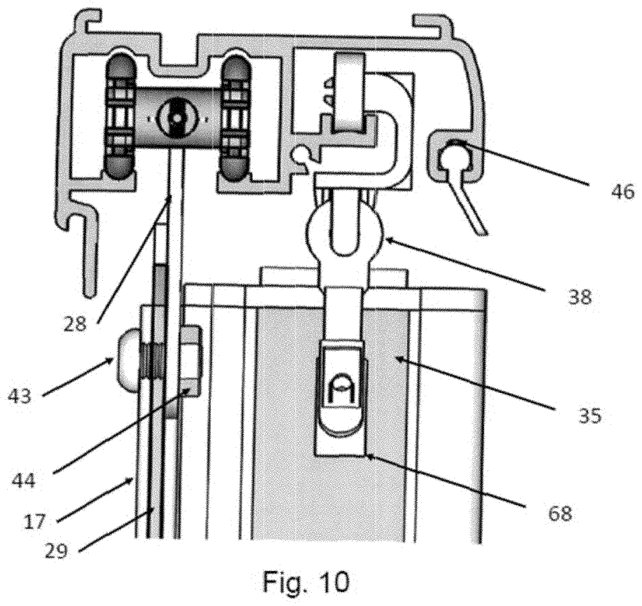

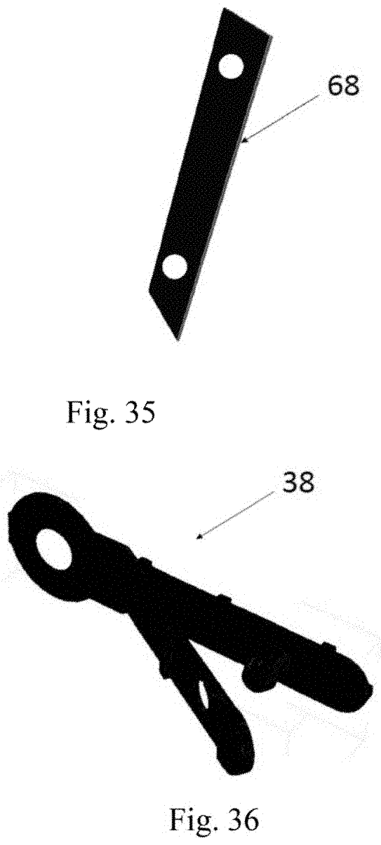

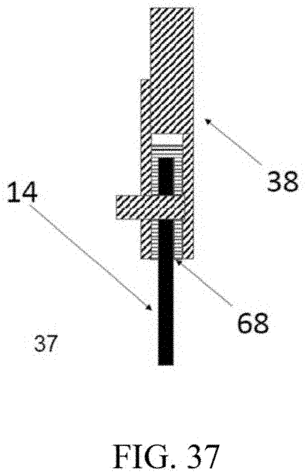

The headrail 12 used in the side-drawn system is a one-piece, extruded material with channels that allow the operation of the vertical retractable covering for structural openings. The materials for the head rail can be selected from the group consisting of aluminum, plastic, steel and fiberglass. Evenly spaced rail carriers 36 that support the pleated fabric covering 14, roller bearings 37, and fabric carriers 38 provide smooth and proper operation of the pleated fabric covering 14 for both the side-drawn and center-drawn operation of the instant invention. The fabric carriers 38 and vertical rails are designed to accommodate a multitude of fabric covering 14 and the fabric carriers 38 attached to the fabric through a hole in the fabric that is reinforced on either one or both sides of the pleat using fabric tape reinforcement 68. The hole in the fabric is formed by first applying the fabric tape reinforcement 68 to the fabric covering 14 and then compressing all the fabric covering 14 and then drilling a hole through all the fabric covering 14 when it is compressed which drills the holes also through the fabric tape reinforcement 68 as shown in FIG. 10, FIG. 35 FIG. 36 and FIG. 37. The fabric tape reinforcer 68 reinforces the fabric covering 14 which eliminates the possibility of the fabric carrier 38 pulling through the fabric covering 14 holes 71. This is due to two reasons the material the adhesive is laminated to a reinforced polymer that forms the fabric tape reinforcer 68. The reinforced polymer has high tensile and shear properties and the adhesive is selected such that it creates a high bond strength to the fabric covering 14 and the reinforced polymer. This allows the hole 71 to be drilled through the reinforced polymer and fabric covering 14 to create a strong reinforced hole to secure the fabric carriers 38 to support the fabric covering 14.

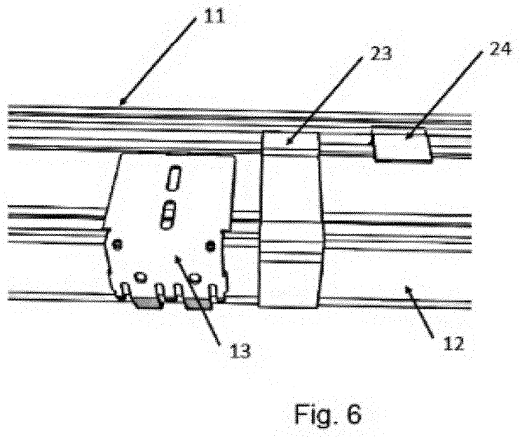

The center-drawn system can contain a plurality of headrails 12 to provide for an adequate length of the structural opening 11 not shown. FIG. 6 illustrates the use of a union 23 to align and attached two headrails 12. The instant invention permits the use of multiple unions 23 to create the desired length of head rail 12 desired to ensure that the structural openings is covered. Also shown, is the installation bracket 13 for attachment of the headrail to the structural opening and supporting members (not shown). The valence clip 24 maintains a parallel relationship of the valence 39 and the headrail 12. The instant invention reduces the number of parts need to fabricate a structural opening cover due to the reversable nature of the movable rail and the fixed rail formed from vertical rail 17. The instant invention basic hardware can be used on both the side-drawn and center-drawn modalities.

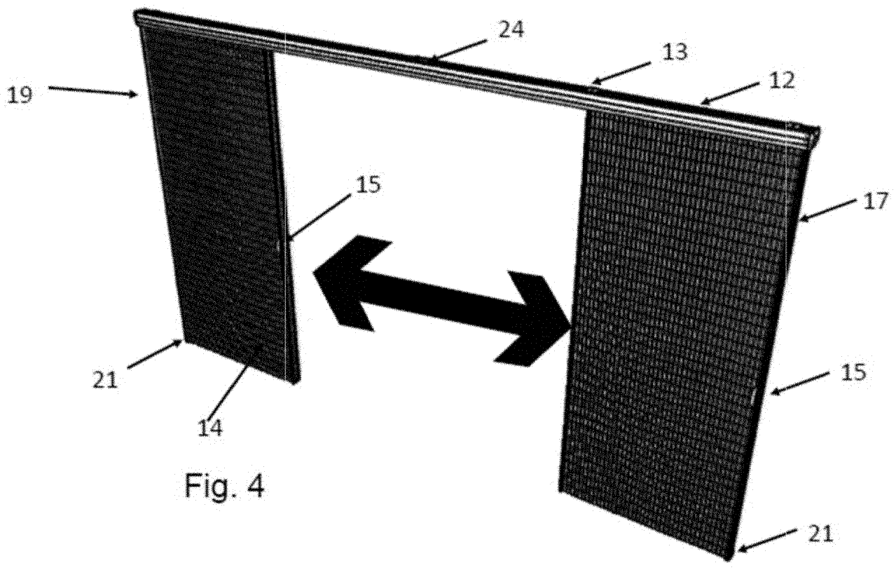

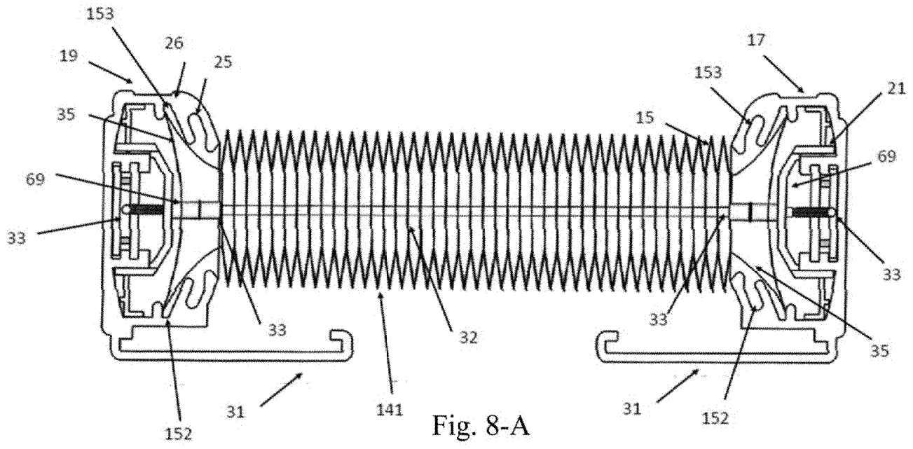

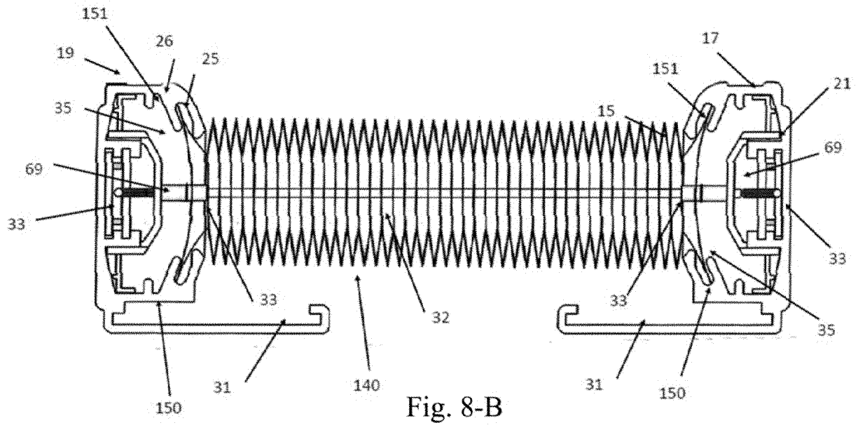

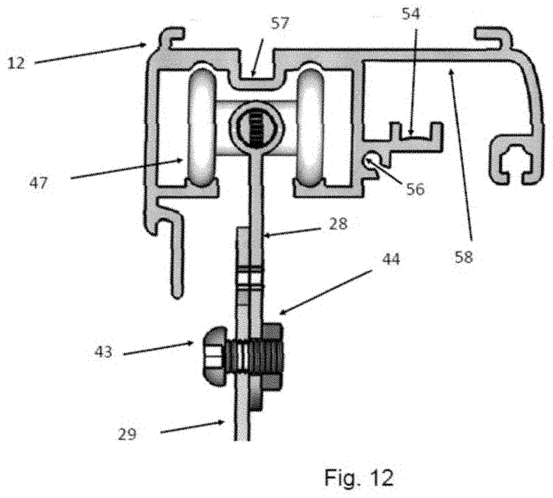

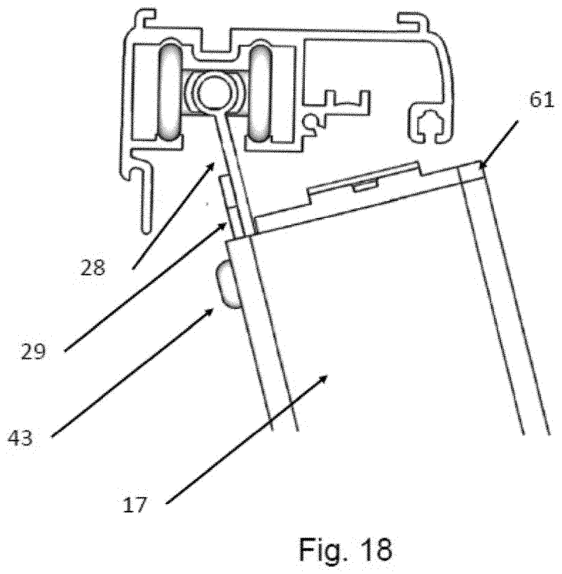

Both the fixed and movable rail are made from vertical rail 17 which are best illustrated in FIGS. 4, 5, and 8 A-B, having identical cross sections but are shown with a mirrored orientation to one another. The movable vertical rail made from vertical rail 17 is can be seen in greater detail in FIG. 4 with an accurate view of the front of the pleated fabric covering 14 partially open. Also shown in FIG. 4 the two receivers that accommodate both common size pleated fabric covering 14 the 9/16″ pleated fabric covering 140 with channel filler 35 in the first receiver formed from channel right side 150 and channel right side 151 and the second receiver for ¾″ pleated fabric covering 141 with channel filler 35 formed from channel right side 152 and channel right side 153 can be seen. Filler 35 is made of either plastic or aluminum and is designed to hold the pleated fabric so it remains in the channel right side 150 and channel right side 151 for the 9/16 fabric 140 and for the ¾″ pleated fabric covering 141 in channel right side 152 and channel right side 153. In FIG. 18A, a J-hook 21 and locking set screw 30 FIG. 8B, are depicted and allow the movable rail made from vertical rail 17 to remain in a fixed position, accommodating a dual, single, and center drawn retractable covering position. All movable rails, regardless of their position are affixed to the trolley 27, pivoting base 28, and swiveling plate 29 which are reversable so the same trolley 27 can be used for either right or left movable vertical rails made from vertical rail 17. Furthermore, each trolley can be locked or fixed by tightening the locking set screw 30 until it engages the headrail 12 as illustrated in FIG. 12.

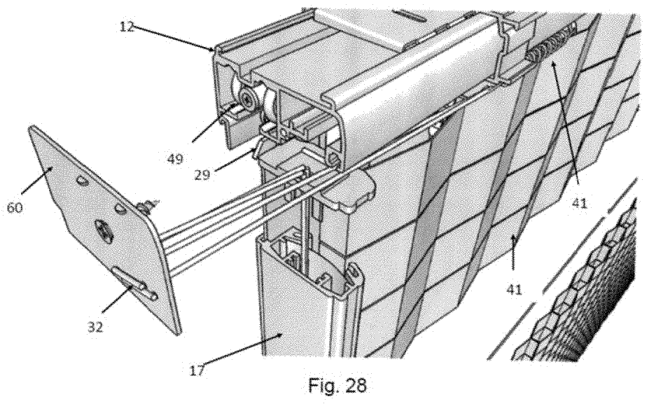

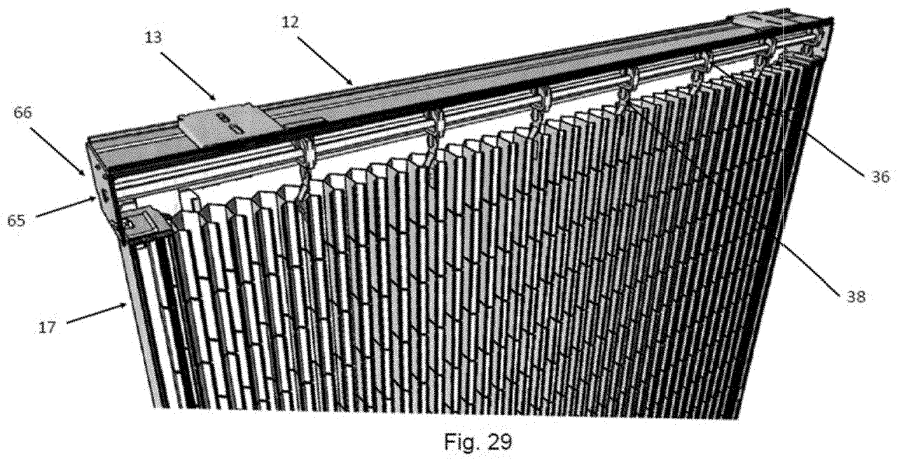

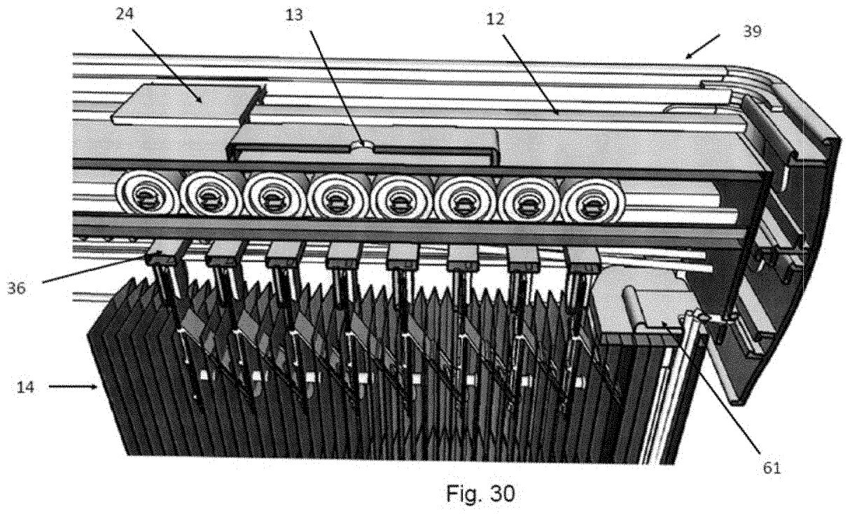

Subsequently, the rail carriers 36 with roller bearings 37 and the attached fabric carriers 38 support and suspend the pleated fabric covering 14 as illustrated in FIG. 29 and can travel the length of the headrail 12 or to the fixed positions of the movable rail 17 as depicted in FIG. 30. This option provides the fixed, dual, single, integral, and center drawn abilities of the pleated fabric covering 14 as illustrated in FIGS. 1, 2, 3, 4, and 5. The use of either pleated fabric covering 14 size 9/16″ 140 or pleated fabric covering 14 size ¾″ 141 covering materials in no way inhibits the type, size, and/or the position of the pleated fabric covering 14 or the movable rail made from vertical rail 17. The many vertical cellular vanes provide a surface for the fabric carrier 38 to clip to the pleated fabric covering 14. The number and spacing of the fabric carriers 38 is determined by the size, type, and weight of the covering material. A plurality of fabric carriers 38, rail carriers 36, and roller bearings 37 are used to support the pleated fabric covering 14 based on the aforementioned pleated fabric covering properties. fabric carriers 38, rail carriers 36, and roller bearings 37 can be constructed of either steel, aluminum or plastic material. Because of the compact design of the trolley 27, a very long pleated fabric covering is accommodated within a very compact material stack, thus allowing longer than normal expanding and collapsing pleated fabric covering draws, as depicted in FIG. 28 The stack width is generally determined by the number and spacing between each cellular pleat of pleated fabric covering 14.

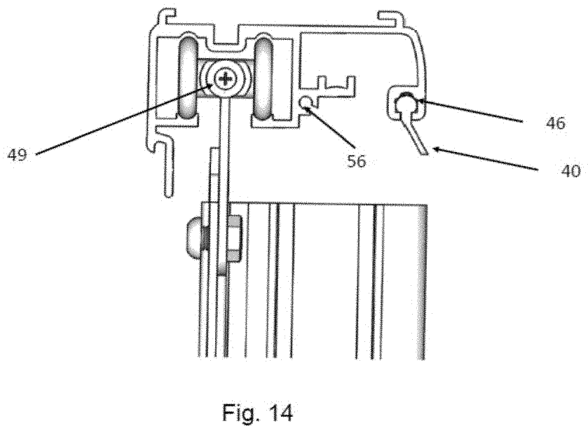

Roller bearings 37, which snap upon the rail carriers 36 are constructed of either steel, aluminum or plastic material with a degree of lubricity and allow the pleated fabric covering 14 to transit the confines of the headrail 12 with a smooth, quiet action while traveling within the track 54 which forms the second track inside the headrail 12, as noted in FIG. 14. This track keeps the roller bearing 37 aligned and also provides a small surface cross-section with reduced wear and friction placed upon the bearings. The attached fabric carriers 38 can also pivot with the trolley 27 and movable rail made from vertical rail 17, ensuring continuity between the pleated fabric covering 14, the trolley 27, and the movable rail made from vertical rail 17 as required by the vertical retractable covering for structural openings. The components are designed to accommodate the movement of the pleated fabric covering 14 along several planes of axial travel.

As previously stated, any movable rail formed from vertical rail made from vertical rail 17 can assume a fixed position and may be affixed to the side frame member of the structural opening with the implementation of the J-hook 21 and set screw 30 in which the expandable and retractable pleated fabric covering 14 is attached. The relationship of the fixed vertical rail made from vertical rail 17, the movable vertical rail made from vertical rail 17, and the headrail 12 can be achieved in various uniform modalities and is further defined hereafter.

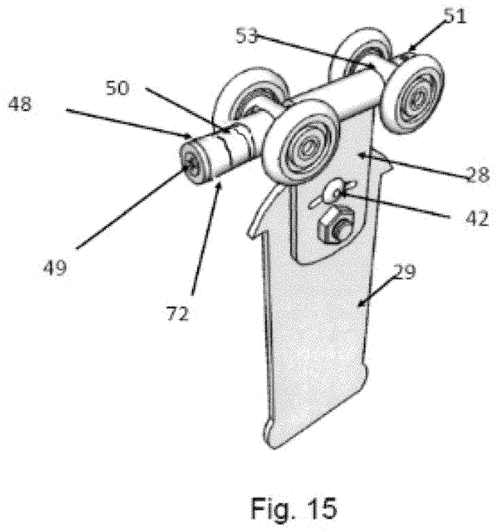

The trolley 27, as shown in FIGS. 15 and 16, supports the movable vertical rail made from vertical rail 17 from first track 59 in the headrail 12. The retractable pleated fabric covering 14 is supported from the rail carriers 36 that support the roller bearings 37, and fabric carriers 38 fabric covering 14 support the movable vertical rail made from vertical rail 17 from the second track 54 in headrail 12. Please note that the trolley is universal and supports both the movable rail, fixed rail, and/or can lock a rail in any position along the length of the headrail. This configuration allows the fixed rail and the movable vertical rail both made from vertical rail 17 to be configured to be fixed or moveable without reconfiguring the rail and trolley system. The trolley can be locked or unlocked from the headrail 12 using screw 30. The trolley 27 is also reversible which allows the installer flexibility and reduces the number of parts they need to install a vertical retractable covering for structural openings. The trolley 27 has a vertical leg 29, the pivoting base 28, and attaches to the swiveling plate 29. The pivoting base 28 is a flat plate with a swivel hole adjacent to its upper end, and allows the plate to attach to the movable vertical rail made from vertical rail 17. The pivoting base has slot which is configured to receive pin 42 on swiveling plate 29 that allows the movable rail to be adjusted such that the retractable pleated fabric covering 14 is parallel in orientation to the structural opening. The pivoting base 28 is constructed of a rigid metallic alloy, plastic or fiberglass material suitable to support the movable vertical rail made from vertical rail 17 and pivoting base 28 and has a proximal end of swiveling plate 29 of a generally cylindrical configuration that is slidably insertable through the movable rail made from vertical rail 17. The pivoting base 28 slides through the channel 31 of the movable rail made from vertical rail 17 and the proximal end of the movable vertical rail made from vertical rail 17 engages the distal end of the swiveling plate 29 allowing the movable vertical rail 17 to slide upwards to a fixed position relative to the headrail 12. The vertical position of the movable rail 17 is essentially the same as the pleated fabric covering 14 and the position, relative to the headrail 12, provides an aesthetically desirable appearance in relationship to the headrail 12, movable rail made from vertical rail 17, and the affixed retractable pleated fabric covering 14. The horizontally moveable trolley 27 can pivot towards and away from the structural opening and is limited in travel, consistent with the confines of the channels within the headrail 12. When the pivoting base 28 is inserted onto the trolley axle 51, the cylindrical opening provides the extents of the pivoting axis. Both the axle and the pivoting base can pivot together and/or independently from one another, ensuring that the movable rail can extend towards or away from the structural opening. This is reversable by inserting the trolley axle 51 either from left to right or right to left into trolley 27 to allow the trolley 27 to be utilized as a right side or left side opening when attached to the movable rail made from vertical rail 17. The trolley 27 of the instant invention is also used to support the fixed vertical rail made from vertical rail 17 which is proximal to the side of structural opening 11. The trolley axle 51 supports two pairs of roller bearing wheel assemblies 53 which have two wheels 47 that ride in track 59. As noted, the trolley axle 51 is reversable and allows the axle spacer 50 to be located to support a left- or right-hand opening method. The axle screw 48 secures the magnet 72, axle shim 49 and axle spacer 50 to the axle 51 and can support either a right-hand or left-hand installation. The magnet 72 is used to hold the movable rail made from vertical rail 17 to the end plate 60 to prevent it from moving unless moved by applying force to the handle 22.

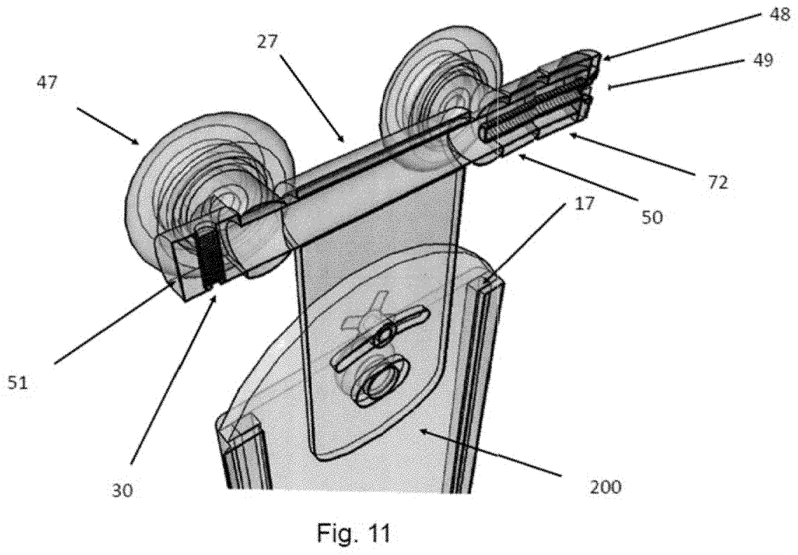

The connection of the pivoting base 28 to the trolley assembly 27 and to the open upper end of the movable rail made from vertical rail 17 is probably best seen using FIGS. 16, 17, 18, 19, 33 and 34. The plate like portion 200 of the swiveling plate 29 and its slidable distal end with relation to the movable vertical rail made from vertical rail 17. The plate-like portion 200 of the vertical leg is retained in a fully inserted position with a pivot plate screw 43 and pivot plate locking nut 44, as best seen in FIG. 11 and FIG. 16, which is slidably received in the first rearwardly opening channel 31 of the movable rail made from vertical rail 17. The pivot plate screw 43 and pivot plate locking nut 44 can alternatively be replaced with a rivet if desired. The pivot plate screw 43 and pivot plate locking nut 44 allows positioning of the movable rail along a parallel axis in relationship to the sides of the structural opening, once the parallel relationship has been acquired, the pivot plate screw 43 and pivot plate locking nut 44 located in can be tightened to lock the movable rail to the desired parallel position to the structural opening 11. The inner wall of the movable rail made from vertical rail 17 has a channel 31 that is align able with swiveling plate 29 when the swiveling plate 29 is fully inserted into the open upper end of the movable rail made from vertical rail 17.

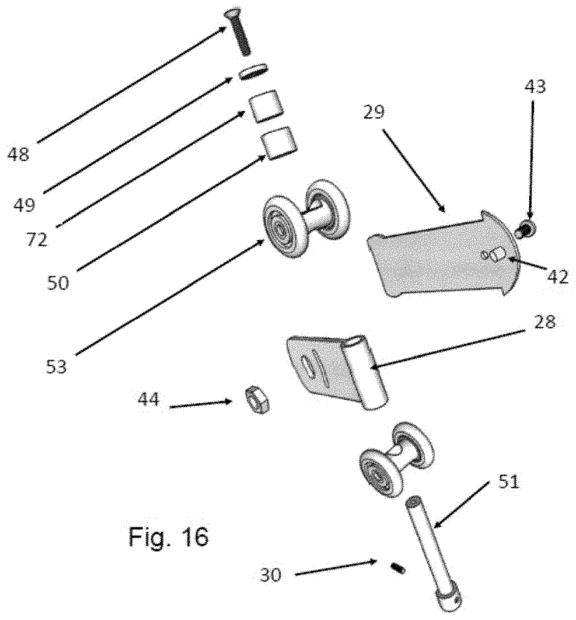

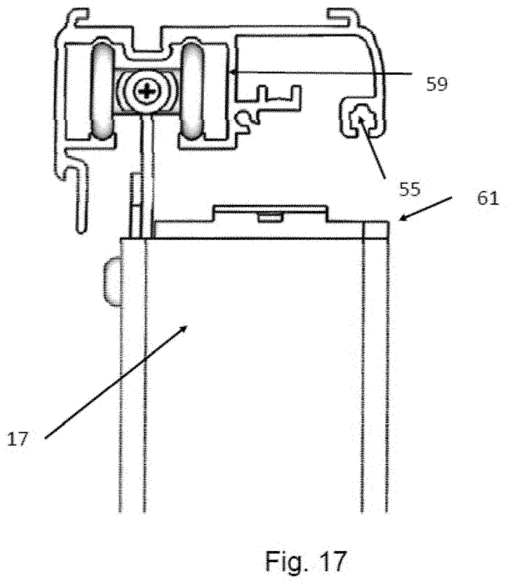

FIGS. 17 and 18 illustrates how the movable rail made formed from vertical rail 17 can pivot about the horizontal axis of the pivoting base 28 as when the covering is being operated. In other words, while it might be desirable to maintain the movable rail made from vertical rail 17 in a vertical orientation as it is slid along the length of the headrail, if the operator were to push or pull the movable rail made from vertical rail 17 perpendicularly to the plane of the panel 14 (FIGS. 17 and 18) during operation, it would cause the swiveling plate 29 of the trolley 27 to pivot, permitting a limited amount of pivotal movement of the movable rail to avoid damage.

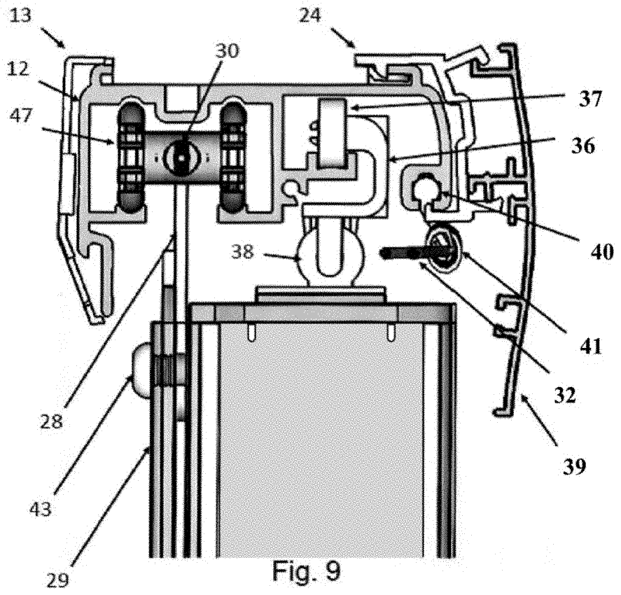

Referring to FIGS. 9-18, the relationship between the trolley 27 to the headrail 12 can be seen. The depiction illustrates a pair of trolley roller bearing wheels 47 at the proximal end of the trolley and are positioned within the confronting inner and outer sidetracks that form the first track of the headrail 12 and trolley is movable along the length of the headrail 12.

As previously stated, the roller bearings 37 on the rail carriers 36 that ride in second track 54 are also confined within the inner side headrail 12 section 58 so that they roll in the same internal proximal location of the headrail as the pair of roller bearing wheels 37 at the proximal end of the trolley 27. There is no interference between the pair of trolley roller bearing wheels 47 and the roller bearings 37 on the rail carriers 36 within the headrail 12 due to the fact that first track 59 and second track 54 are separate and each supports unique rolling apparatus trolley 27 in first track 59 and roller bearings 37 on the rail carriers 36 that ride in second track 54. The however the roller bearings 37 of the rail carriers 36 are disposed inside the channel 54 of the headrail 12 which allows the panel material 14 to be accumulated along the length of the headrail 12. The moveable rail 17 is supported by the trolley 27 which runs in channel 59 which is defined as the first track of headrail 12. This facilitates the pleated fabric covering to be uniformly gathered in an aesthetically pleasing manner when the covering is collapsed and the pleated fabric covering can gather along the length of the horizontal trolley transit in a uniform manner with its gathering along the remainder of the headrail.

FIG. 11-14 depict the relationship of the trolley 27 to the headrail 12 and it can be clearly seen how the pair of trolley roller bearing wheels 47 are confined within the channels 59 forming the first track in headrail 12, and in FIG. 11 and FIG. 12 how the trolley roller bearing wheel 47 at the distal end of the trolley is confined within the channel 59. As previously stated, the single roller bearing wheel is rotatably mounted in an ovular or non-circular channel 59 so as to maintain desired alignment with the headrail 12, and the threaded locking screw 30 can be advanced against the flat portion of the channel and thus the trolley against the top wall of the headrail 12 to assure a horizontal disposition of the movable vertical rail 17.

As previously stated, the distal end of the swiveling plate 29 of the trolley 27 is not supported other than by force of gravity on the movable rail 17 which urges the movable rail and thus the pivoting base 28 of the trolley into a vertical disposition. It is aesthetically desirable to make sure that the movable rail is always vertically disposed which maintains a rolling engagement of the single roller bearing wheel 37 against the channel 54 which forms the second track of the headrail 12 once the roller bearing wheel 37 has been desirably adjusted as mentioned above. The orientation of the movable vertical rail is achieved with the stabilizing cord system mentioned previously which assures that the movable rail 17 remains parallel with the fixed vertical rail made from vertical rail 17 at all times. The fixed vertical rail made from vertical rail 17 is locked in position through its attachment to a J-hook 21 and the engagement of the locking set sew 30 as part of the trolley assembly. Pin 42 are used to lock swiveling plate 29 in position with respect to pivoting base 28 using screw 43 and nut 44.

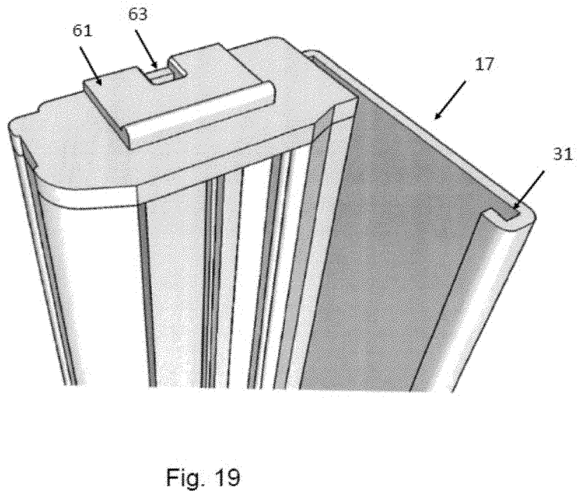

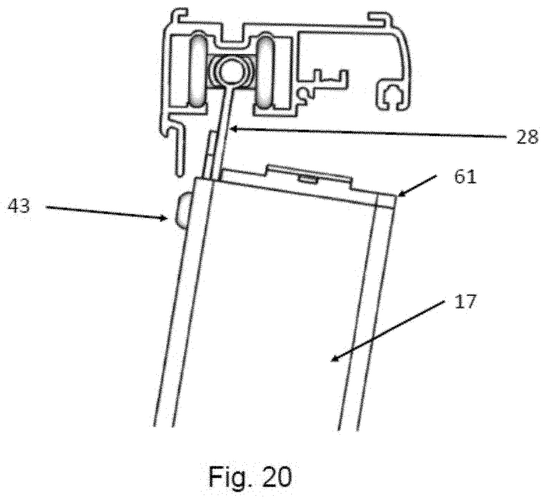

To further elaborate, the stabilizing cord system that the fixed vertical rail made from vertical rail 17 is not only anchored to a side frame member of the structural opening, but is suspended from the headrail 12 with a cord guide end cap 61 seen best in FIG. 8 and FIG. 19 to assure a uniform relationship with the fixed rail made from vertical rail 17 with the headrail 12. The cord guide end cap 61 has at least two elongated vertical stakes 64 with a transverse passage 63 and the body is designed to be slidably inserted into the forwardly opening channel on the rear of moveable rail 17 as seen in FIG. 20. Again, a set screw 30 is used on the fixed rail in the same manner as it is used on the movable rail to secure the vertical rail in position as seen in FIGS. 11 and 12. The cord guide end cap 61 has an enlarged head protruding upwardly from the upper end of the fixed rail with at least two elongated vertical stake 64 defined therein adapted to frictionally attach to the groves 57 in the moveable rail 17 of the headrail so that the vertical relationship of the fixed rail to the headrail is always the same.

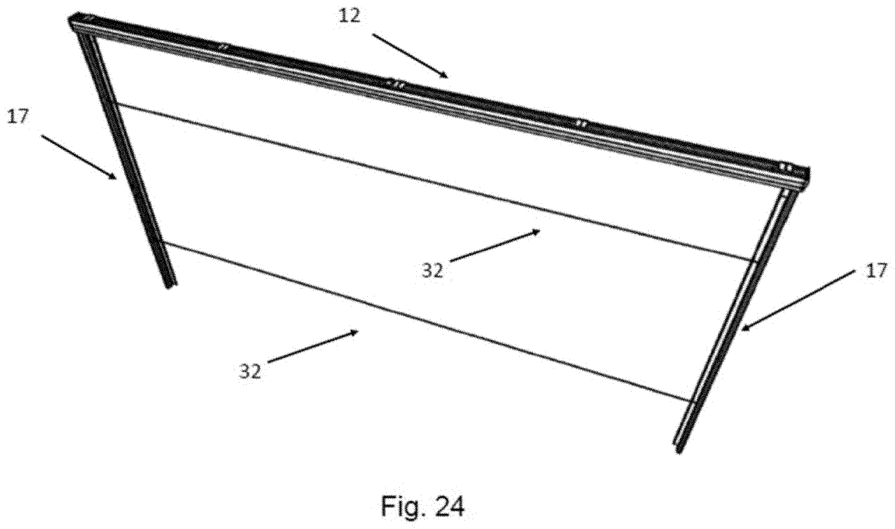

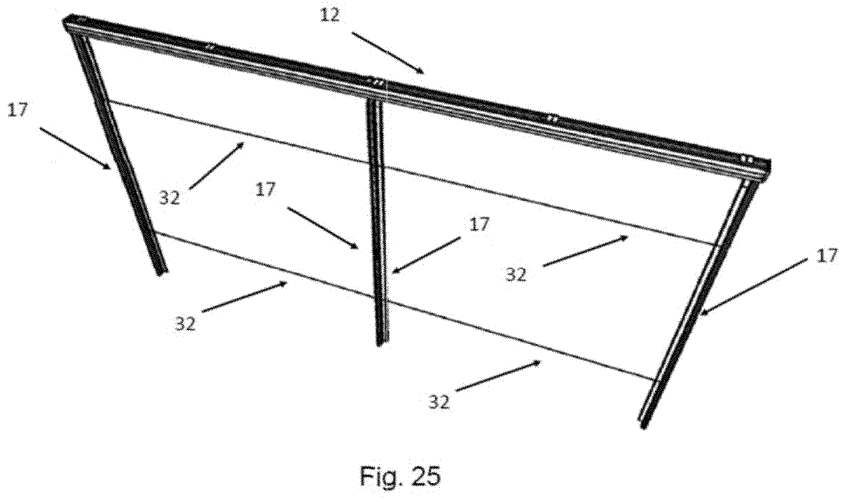

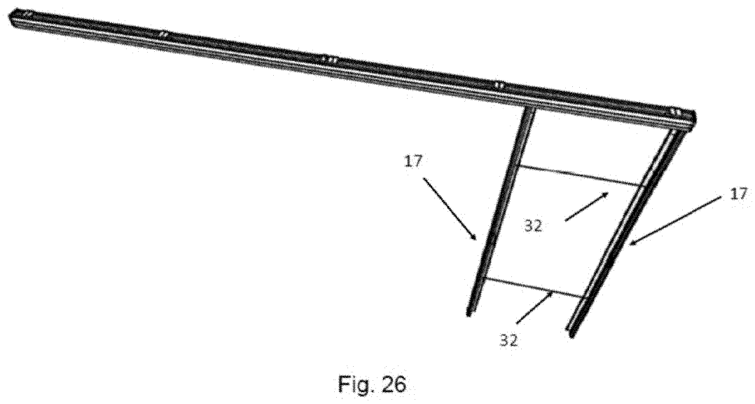

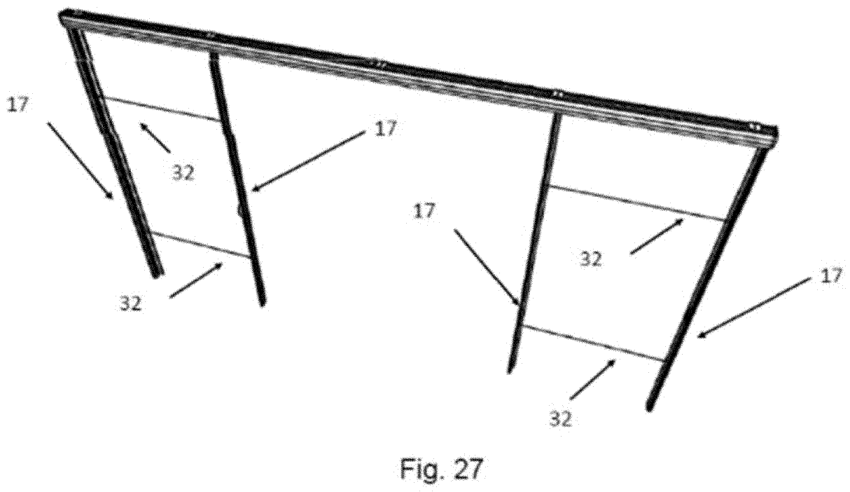

The stabilizing cord system is accurately depicted by referencing FIG. 24 and FIGS. 25 and 26 illustrate the stabilizing cord system for a side-draw system, while FIGS. 25 and 27 illustrate the stabilizing cord system for a center-draw system. In the stabilizing cord system of the side-draw system, as seen in FIGS. 24 and 26, and as will be explained in more detail hereafter, there are two non-extensible cords 32 which is anchored to the end plate 60 of the headrail at the opposite end of the headrail from the fixed rail made from vertical rail 17. The cord is anchored to the end plate as illustrated in FIG. 28 by looping the cords through the horizontal holes described previously in the associated end cap. This connection firmly positions one end of the stabilizing cord. The cord serpentines through the pleated fabric covering and provides a slidable axis for it to expand and collapse uniformly upon. Tension is placed upon the cord system with the use of a spring 41 and adjustment of the cord tensioner 40 in feature 46 of headrail 12. The cord is slidably passed through the cord guide end cap 61 in the fixed rail and passed downwardly through the fixed vertical rail where it is anchored at the end of the head rail, upon the end plate and attached at the other end to the spring. As will be appreciated, this arrangement maintains a parallel relationship between the movable rail and the fixed rail in which a parallel relationship remains during sliding operation of the movable rail along the headrail 12. End plate 60 is attached to the headrail 12 by screw 65 attaching to the feature 56 in headrail 12.

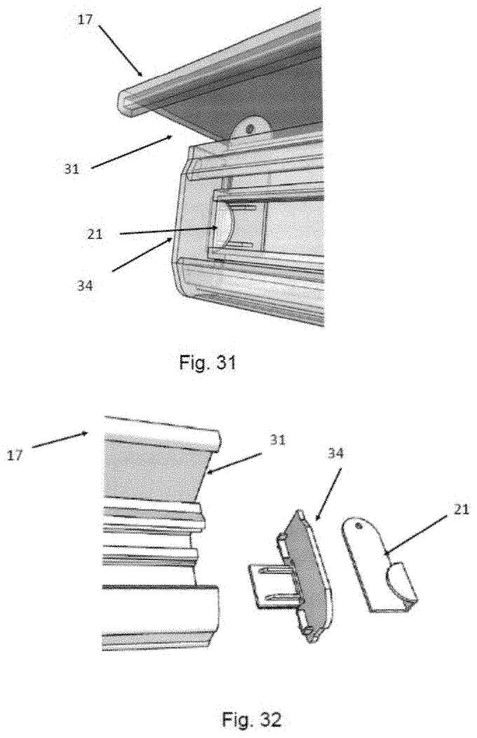

The bottom end cap 34, as seen in FIG. 31 and FIG. 32 at the lower end of the vertical rail, can be used to anchor the movable rail 17 as desired. The Vertical Rail End Cap 34 of the vertical rail is similar to the cord guide end cap 61 of the vertical rail abet being inverted in configuration with each of the end caps having at least two elongated vertical stake 64 for frictional engagement with the channels of the vertical rails to which they are attached to releasably retain the end caps in position. As mentioned previously, there is a hole passing through the cord guide caps 61 and each hole has defined area formed therein to receive either the stabilizing cord. To prevent entanglement, the stabilizing cord enters the cord guide end cap 61 of the movable rail, as seen best in FIGS. 19 and 20, and extended through one of the channels so that the cord is somewhat aligned along the length of the vertical rail. Removal of slack in the stabilizing cord, of course, maintains the parallel and vertical relationship between the fixed and movable vertical rails regardless of their horizontal separation from each other as occurs during expanding and collapsing of the covering material.

Of course, maintaining the parallel relationship between the movable rail 17 and the fixed rail made from vertical rail 17 assures a vertical orientation of the movable rail made from vertical rail 17 and thus the swiveling plate 29 of the trolley 27 which retains the horizontal leg of the trolley in a horizontal orientation with the single trolley roller bearing wheel 47 positively engaged within the channel 59 on the lower surface of the top wall of the headrail 12.

Furthermore, in the center-draw system has two handles 22, the movable rails made from vertical rail 17 are again retained in parallel relationship with the associated fixed rails made from vertical rail 17 so that the horizontal legs of the associated trolley 27 are also maintained in a horizontal orientation with their single trolley roller bearing wheel 47 positively engaged in the upper track 59 of the headrail.

The Vertical Retractable Covering for Structural Openings has been described herein with fixed and movable rails along opposite side edges of an expanding and collapsing pleated fabric covering and is retained in a parallel relationship, while a trolley connecting the movable vertical rail to the headrail is retained in a desired relationship to assure smooth gliding movement of the movable rail along the length of the headrail between extended and retracted positions of the covering. It should also be appreciated that the use of a single roller bearing wheel at the distal end of the of the trolley engageable in a single channel separate from a channel utilized by the rail carriers for supporting the pleated fabric covering enables the rail carriers to stack along the horizontal length of the trolley to permit uniform gathering of the pleated fabric covering along its full width including the portion of the covering that overlies the length of the trolley.

Although the Vertical Retractable Covering for Structural Openings has been described with a certain degree of particularity, let it be understood that the disclosure has been made by way of example, and changes in detail or structure may be made without departing from the spirit of the invention as defined in the appended claims.

While this invention has been described with respect to at least one embodiment, the instant invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1) A retractable covering movable between extended and retracted positions comprising of:
a. a fabric covering panel having a plurality of pleats and said fabric covering having a first proximal pleat and a second distal pleat and being horizontally collapsible;
b. an elongated horizontal headrail comprising of a headrail rail comprising of a horizontal rail and two end plates;
c. Said headrail rail having at least two tracks wherein a proximal track is configured to support at least one first proximal trolley and second distal track is configured to support at least a first distal trolley and a second distal trolley;
d. said at least first distal trolley is selectively fixed to said headrail rail and supports a vertical rail and said second distal trolley supports a vertical rail and said second distal trolley is moveable in said second distal track and said at least one proximal trolley supports a fabric covering panel;
e. said at least first distal trolley comprising of two chassis wheel assemblies each comprising of two wheels configure to roll in said second distal track of said headrail and a trolley axle connecting the said two chassis wheel assemblies and a magnet attached to said trolley axle said magnet in communication with an end plate attached to the end of said headrail rail and said at least first distal trolley connected to said vertical rail and said fabric covering panel connected to said vertical rail;
f. and said at least second distal trolley comprising of two chassis wheel assemblies each comprising of two wheels configure to roll in said second distal track of said headrail and a trolley axle connecting the said two chassis wheel assemblies and a magnet attached to said trolley axle said magnet in communication with an end plate attached to the end of said headrail rail and said at least at least second distal trolley connected to said vertical rail and said fabric covering panel connected to said vertical rail;
g. said fabric covering panel being attached to said first distal trolley vertical rail at a receiver for said fabric covering panel using said first proximal pleat and said fabric covering having a filler captured in said first proximal pleat of said fabric covering panel of said fabric covering panel;
h. said fabric covering panel being attached to said second distal trolley vertical rail at a receiver for said fabric covering panel using said second distal pleat and said fabric covering having a filler captured in said second proximal pleat of said fabric covering panel of said fabric covering panel;
i. said at least one proximal trolley supports said fabric covering panel having holes and said fabric covering panel attached to said at least one proximal trolley by fabric carriers attached to said fabric covering panel and said fabric covering panel having a polymer and adhesive reinforcing member attached to said fabric covering panel at the holes adapted to receive the said fabric carriers; and
j. said fabric covering panel being attached and suspended from said head rail by the at least one proximal trolley and the said first and second distal trolleys.

2) The covering of claim 1 wherein said first and second distal trolleys further includes a vertical leg secured to said vertical rail, said vertical leg being pivotal about said first and second distal trolley axle to permit said vertical rail to pivot within a vertical plane.

3) The vertical rail of claim 1 having a first receiver and a second receiver capable of receiving two different sizes of said fabric covering panel.

4) The first and second distal trolley of claim 1 wherein said first and second distal trolley further includes a vertical leg secured to said vertical rail, said vertical leg being pivotal about said first and second distal trolley axle to permit said vertical rail to pivot within a vertical plane.

5) The vertical rail of claim 1 wherein the said vertical rail first distal trolley is capable of receiving a said fabric covering panel with said filler in a first receiver such that the said fabric covering panel is attached to said first distal trolley vertical rail at said first receiver.

6) The vertical rail of claim 1 wherein the said vertical rail second distal trolley of is capable of receiving a said fabric covering panel with said filler in a first receiver such that the said fabric covering panel is attached to said second distal trolley vertical rail at said first receiver.

7) The vertical rail of claim 1 wherein the said vertical rail first distal trolley is capable of receiving a said fabric covering panel with said filler in a second receiver such that the said fabric covering panel is attached to said first distal trolley vertical rail at said second receiver.

8) The vertical rail of claim 1 wherein the said vertical rail second distal trolley of is capable of receiving a said fabric covering panel with said filler in a second receiver such that the said fabric covering panel is attached to said second distal trolley vertical rail at said second receiver.

9) The filler of claim 1 wherein said filler is selected from the group consisting of plastic and aluminum.

10) The first distal trolley of claim 1 being reversable such that it can be configured to be a second distal trolley by reversing the trolley axle direction.

11) The second distal trolley of claim 1 being reversable such that it can be configured to be a first distal trolley by reversing the trolley axle direction.

12) A retractable covering movable between extended and retracted positions comprising of a fabric covering panel having a plurality of pleats the first pleat being proximal and the second pleat being distal and said fabric covering panel being horizontally collapsible, an elongated horizontal headrail comprising of a headrail rail and two end plates and said headrail rail having a first track adaptable for supporting a first trolley and a second trolley and a second track adaptable for supporting at least two rail carriers wherein:
a. said headrail rail supporting said first trolley and said second trolley in said first track such that said first trolley is moveable in said first track and said second trolley is moveable in said first track and said first trolley supports a vertical rail and said second trolley supports a vertical rail;
b. said second trolley comprising of two chassis wheel assemblies each comprising of two wheels configure to roll in said first track of said headrail and a trolley axle connecting the said two chassis wheel assemblies and a magnet attached to said trolley axle said magnet in communication with an end plate attached to the end of said headrail rail and said second trolley of being reversable such that it can be configured to be a first trolley by reversing the trolley axle direction;
c. said fabric covering panel being attached to said second trolley vertical rail using said second distal pleat at a receiver for said fabric covering panel and said fabric covering second distal pleat having a filler to spread said fabric covering pleat to captured said second distal pleat in said receiver;
d. said fabric covering panel being attached to said first trolley vertical rail using said first proximal pleat at a receiver for said fabric covering panel and said fabric covering first proximal pleat having a filler to spread said fabric covering pleat to captured said first proximal pleat in said receiver;
e. said first trolley comprising of two chassis wheel assemblies each comprising of two wheels configure to roll in said first track of said headrail, a trolley axle connecting the said two chassis wheel assemblies and a screw located in said chassis wheel assembly to connect the trolley to the headrail rail and a magnet attached to said trolley axle said magnet in communication with said at least one end plate attached to the end of said headrail rail, and said vertical rail attached to said first trolley and said first trolley of being reversable such that it can be configured to be a second trolley by reversing the trolley axle direction;
f. said second trolley comprising of two chassis wheel assemblies each comprising of two wheels configure to roll in said first track of said headrail, a trolley axle connecting the said two chassis wheel assemblies and a screw located in said chassis wheel assembly to connect the trolley to the headrail rail and a magnet attached to said trolley axle said magnet in communication with said at least one end plate attached to the end of said headrail rail, and said vertical rail attached to said second trolley; and
g. said second track supporting said rail carriers which are attached to said fabric carriers and said fabric carriers are attached to said fabric covering panel at said holes in said fabric covering panel and said fabric covering panel having a polymer and adhesive reinforcing member attached to said fabric.

13) The covering of claim 12 wherein said second trolley further includes a vertical leg secured to said vertical rail, said vertical leg being pivotal about said distal trolley axle to permit said vertical rail to pivot within a vertical plane.

14) The vertical rail of claim 12 having a first receiver and a second receiver capable of receiving two different sizes of said fabric covering panel.

15) The covering of claim 12 wherein said first trolley further includes a vertical leg secured to said vertical rail, said vertical leg being pivotal about said proximal trolley axle to permit said vertical rail to pivot within a vertical plane.

16) The vertical rail of claim 12 wherein the said vertical rail is capable of receiving a said fabric covering panel size in a first receiver such that the said fabric covering panel is attached to said proximal trolley vertical rail at said first receiver.

17) The vertical rail of claim 12 wherein the said vertical rail is capable of receiving a said fabric covering panel size in a first receiver such that the said fabric covering panel is attached to said distal trolley vertical rail at said first receiver.

18) The vertical rail of claim 12 wherein the said vertical rail is capable of receiving a said fabric covering panel size in a second receiver such that the said fabric covering panel is attached to said proximal trolley vertical rail at said second receiver.

19) The vertical rail of claim 11 wherein the said vertical rail is capable of receiving a said fabric covering panel size in a second receiver such that the said fabric covering panel is attached to said distal trolley vertical rail at said second receiver.

20) The filler of claim 12 wherein said filler is selected from the group consisting of plastic and aluminum.
